(19) United States
(12) Patent Application Publication
(10) Pub. No.: US 2002/0150047 A1
(43) Pub. Date: Oct. 17, 2002

(54) System and method for scheduling transmission of asynchronous transfer mode cells

(75) Inventors: Brian James Knight, Cambridge (GB); Timothy John Chick, Bedfordshire (GB); Guido Barzini, Cambridge (GB)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(73) Assignee: GlobespanVirata Incorporated, Red Bank, NJ

(21) Appl. No.: 10/063,385

(22) Filed: Apr. 17, 2002

Related U.S. Application Data
(60) Provisional application No. 60/284,168, filed on Apr. 17, 2001.

(51) Int. Cl. H04L 12/26; H04L 12/56

(52) U.S. Cl. 370/230.1; 370/395.43

(57) ABSTRACT

A system and method for scheduling the transmission of ATM cells is provided which includes two discrete processors. One processor examines the virtual channels and their traffic parameters, and calculates the times at which cells should be transmitted from each channel. The second processor manages multiple ATM network ports, performs low-level cell handling and the majority of cell switching, and transmits cells when instructed by the first.

### CROSS REFERENCE TO RELATED APPLICATIONS

This application claims the benefit of U.S. provisional patent application Serial No. 60/284,168 filed Apr. 17, 2001, the disclosure of which is incorporated herein by reference.

### BACKGROUND OF THE INVENTION

The present invention relates generally to data communication networks and, more particularly, to transmission control mechanisms, including ATM communications processors and switches, and cell reception and header interpretation in asynchronous transfer mode systems/networks.

With the proliferation of the digital age, increasing need has arisen for a single versatile networking technology capable of efficiently transmitting multiple types of information at high speed across different network environments. In response to this need, the International Telegraph and Telephone Consultative Committee (CCITT), and its successor organization, the Telecommunications Standardization Sector of the International Telecommunication Union (ITU-T), developed Asynchronous Transfer Mode, commonly referred to as ATM, as a technology capable of the high speed transfer of voice, video, and data across public and private networks.

ATM utilizes very large-scale integration (VLSI) technology to segment data into individual packets, e.g., B-ISDN calls for packets having a fixed size of 53 bytes or octets. These packets are commonly referred to as cells. Using the B-ISDN 53-byte packet for purposes of illustration, each ATM cell includes a header portion comprising the first 5 bytes and a payload portion comprising the remaining 48 bytes. ATM cells are routed across the various networks by passing though ATM switches, which read addressing information included in the cell header and deliver the cell to the destination referenced therein. Unlike other types of networking protocols, ATM does not rely upon Time Division Multiplexing in order to establish the identification of each cell. That is, rather than identifying cells by their time position in a multiplexed data stream, ATM cells are identified solely based upon information contained within the cell header.

Further, ATM differs from systems based upon conventional network architectures such as Ethernet or Token Ring in that rather than broadcasting data packets on a shared wire for all network members to receive, ATM cells dictate the successive recipient of the cell through information contained within the cell header. That is, a specific routing path through the network, called a virtual path (VP) or virtual circuit (VC), is set up between two end nodes before any data is transmitted. Cells identified with a particular virtual circuit are delivered to only those nodes on that virtual circuit. In this manner, only the destination identified in the cell header receives the transmitted cell.

The cell header includes, among other information, addressing information that essentially describes the source of the cell or where the cell is coming from and its assigned destination. Although ATM evolved from Time Division Multiplexing (TDM) concepts, cells from multiple sources are statistically multiplexed into a single transmission facility. Cells are identified by the contents of their headers rather than by their time position in the multiplexed stream. A single ATM transmission facility may carry hundreds of thousands of ATM cells per second originating from a multiplicity of sources and traveling to a multiplicity of destinations.

The backbone of an ATM network consists of switching devices capable of handling the high-speed ATM cell streams. The switching components of these devices, commonly referred to as the switch fabric, perform the switching function required to implement a virtual circuit by receiving ATM cells from an input port, analyzing the information in the header of the incoming cells in real-time, and routing them to the appropriate destination port. Millions of cells per second need to be switched by a single device.

Importantly, this connection-oriented scheme permits an ATM network to guarantee the minimum amount of bandwidth required by each connection. Such guarantees are made when the connection is set-up. When a connection is requested, an analysis of existing connections is performed to determine if enough total bandwidth remains within the network to service the new connection at its requested capacity. If the necessary bandwidth is not available, the connection is refused.

In order to achieve efficient use of network resources, bandwidth is allocated to established connections under a statistical multiplexing scheme. Therefore, congestion conditions may occasionally occur within the ATM network resulting in cell transmission delay or even cell loss. To ensure that the burden of network congestion is placed upon those connections most able to handle it, ATM offers multiple grades of service. These grades of service support various forms of traffic requiring different levels of cell loss probability, transmission delay, and transmission delay variance, commonly known as delay jitter. It is known, for instance, that many multimedia connections, e.g., video streams, can tolerate relatively large cell losses, but are very sensitive to delay variations from one cell to the next. In contrast, traditional forms of data traffic are more tolerant of large transmission delays and delay variance, but require very low cell losses. This variation in requirements can be exploited to increase network performance.

In particular, the following grades of service are preferably supported in modern ATM networks: constant bit rate (“CBR”) circuits, variable bit rate (“VBR”) circuits, and unspecified bit rate (“UBR”) circuits. These categories define the qualities of service available to a particular connection, and are selected when a connection is established. More specific definitions of each of these categories are set forth below. A CBR virtual circuit is granted a permanent allocation of bandwidth along its entire path. The sender is guaranteed a precise time interval, or fixed rate, to send data, corresponding to the needed bandwidth, and the network guarantees to transmit this data with minimal delay and delay jitter. A CBR circuit is most appropriate for real-time video and audio multimedia streams which require network service equivalent to that provided by a synchronous transmission network. From the perspective of the source and destination, it must appear as if a virtual piece of wire exists between the two points. This requires that the transmission of each cell belonging to this data stream occur at precise intervals. A VBR virtual circuit is initially specified with an average bandwidth and a peak cell rate. This type of circuit is appropriate for high priority continuous traffic which contains some burstiness, such as compressed video streams. The network may “overbook” these connections on the assumption that not all VBR circuits will be handling traffic at a peak cell rate simultaneously. However, although the transmission rate may vary, applications employing VBR service often require low delay and delay jitter. The VBR service is further divided into real-time VBR (rt-VBR) and non-real-time VBR (nrt-VBR). These two classes are distinguished by the need for an upper bound delay (Max CTD). MaxCTD is provided by rt-VBR, whereas for nrt-VBR no delay bounds are applicable.

A UBR virtual circuit, sometimes referred to as connectionless data traffic, is employed for the lowest priority data transmission; it has no specified associated bandwidth. The sender may send its data as it wishes, but the network makes no guarantee that the data will arrive at its destination within any particular time frame. This service is intended for applications with minimal service requirements, e.g., file transfers submitted in the background of a workstation. A particular end-node on the network may have many virtual circuits of these varying classes open at any one time. The network interface at the end-node is charged with the task of scheduling the transmission of cells from each of these virtual circuits in some ordered fashion. At a minimum, this will entail pacing of cells from CBR circuits at a fixed rate to achieve virtual synchronous transmission. Additionally, some form of scheduling may be implemented within some or all of the switches which form the ATM network. Connections which have deviated from their ideal transmission profile as a result of anomalies in the network can be returned to an acceptable service grade.

The design of conventional ATM switching systems involves a compromise between which operations should be performed in hardware and which in software. Generally, but not without exception, hardware gives optimal performance, while software allows greater flexibility and control over scheduling and buffering, and makes it practical to have more sophisticated cell processing (e.g., OAM cell extraction, etc.).

Additional background information pertaining to ATM can be found in a number of sources and need not be repeated directly herein. For example, U.S. Pat. No. 6,122,279 (Milway et al.), assigned to the assignee of the present invention, provides a thorough description of ATM and is incorporated herein by reference. In addition, U.S. Pat. No. 5,953,336 (Moore et al.), also assigned to the assignee of the present invention, provides background on ATM traffic shaping, among other things, and is likewise incorporated herein by reference.

Relative to traffic shaping, the small size of ATM cells allows fine-grain interleaving of multiple data streams on a single physical connection, which means that it is possible to maintain the contracted quality of service individually for each stream. However, this is hard to achieve in practice, as the data streams will have different traffic parameters, different priorities, and the data to be transmitted may be arriving from multiple sources, and may be a mixture of ready-formatted cells and buffers which must be segmented.

Accordingly, there is a need in the art of ATM networking for a more flexible method and system for shaping ATM traffic.

### SUMMARY OF THE INVENTION

The present invention overcomes the problems noted above, and realizes additional advantages, by providing for methods and systems for scheduling the transmission of ATM cells. In particular, a system is provided which includes two discrete processors. One processor examines the virtual channels and their traffic parameters, and calculates the times at which cells should be transmitted from each channel. The second processor manages multiple ATM network ports, performs low-level cell handling and the majority of cell switching, and transmits cells when instructed by the first.

In addition and by way of example and not limitation, this inventive aspect differentiates over other known systems and methods, for example U.S. Pat. No. 5,953,336, in the following respects, by: supporting multiple ATM ports (of different speeds); reshaping switched traffic as well as locally-originated traffic; supporting rt-VBR and nrt-VBR traffic classes; implementing a configuration allowing the use of multiple processors; providing an output of the shaping engine in the form of a stream of transmission commands for the NP rather than ATM cells and written directly to a hardware port; handling CBR (constant bit rate) in the same way as other traffic classes; and the traffic class and the priority being orthogonal.

### BRIEF DESCRIPTION OF THE DRAWINGS

The present invention can be understood more completely by reading the following Detailed Description of the Invention, in conjunction with the accompanying drawings, in which:

FIG. 1 is a schematic block diagram illustrating one embodiment of a dual-processor hardware configuration incorporated in the traffic shaping system of the present invention;

FIG. 2 is a schematic block diagram illustrating one embodiment of the traffic shaping system of the present invention;

FIG. 3 is a block diagram illustrating the traffic shaping engine of FIG. 2;

FIG. 4 is a flow diagram illustrating one embodiment of a method for shaping ATM traffic on an output port in accordance with the present invention;

FIG. 5 is a block diagram illustrating the traffic shaping engine of FIG. 2; and

FIG. 6 is a flow diagram illustrating one embodiment of a method for scheduling ATM ports in accordance with the present invention.

### DETAILED DESCRIPTION OF THE PREFERRED EMBODIMENTS

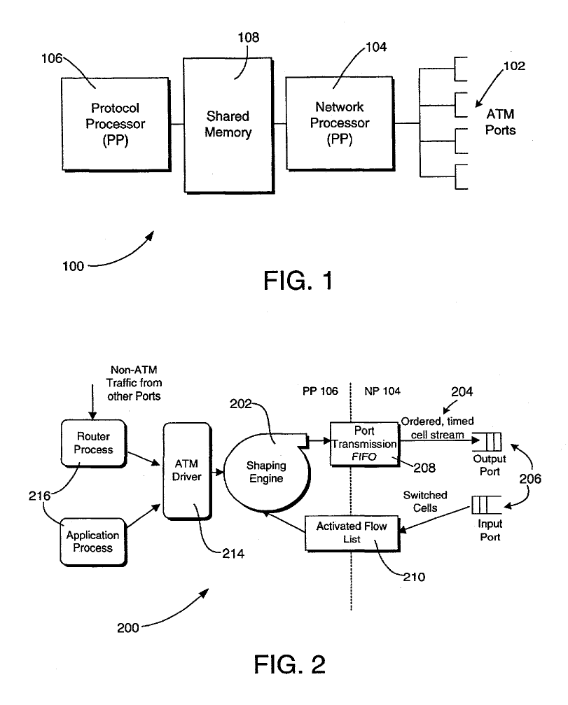

The following description is intended to convey a thorough understanding of the invention by providing a number of specific embodiments and details involving ATM processing and systems. It is understood, however, that the invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs. Now referring to the Figures and, in particular, FIG. 1, there is shown a schematic block diagram illustrating one embodiment of a dual-processor hardware configuration 100 incorporated in the traffic shaping system of the present invention. In particular, the hardware configuration 100 includes several ATM ports 102 for both receiving and transmitting ATM cells to neighboring network nodes. Two processors 104 and 106 are also included as well as a memory 108 which is shared by the two processors. In one embodiment, the first processor 104 (hereinafter referred to as the Network Processor or NP) handles low-level transmission and reception of ATM cells. This may include, for example, segmentation and re-assembly functions, as well as the scheduling of port servicing. The NP 104 may also handle other network ports and have hard real-time requirements on the behavior of its software. The second processor (dubbed the Protocol Processor or PP) 106 conversely handles higher level protocols and performs functions, such as bridging and routing.

In the example embodiment described in detail below, two general types of sources may generate ATM traffic handled by the above hardware configuration. A first type of source includes locally originated ATM traffic. Locally originated ATM traffic is defined as traffic that is locally generated as far as an ATM driver on the PP 106 is concerned. For example, this locally originated traffic may be created by a process on the PP 106 or, alternatively, the traffic may consist of packets bridged or routed from another network interface (which might not be considered locally generated in the system as a whole, but which is considered locally generated for the instant example). In general this bridged or routed traffic is held as buffers which correspond to groupings of several ATM cells (e.g., AAL5 packets) and which must be segmented into discrete cells before transmission from an output port.

The second source of ATM traffic includes switched ATM cells which arrives on the ATM ports and are switched individually to one or more ports as they arrive. Switched circuits may be unicast, with one output cell for each input cell, or multicast, wherein each input cell is replicated to several branches (which may be on different output ports). ATM traffic streams from both types of sources are carried by virtual circuits or virtual paths, which we will refer to generically as flows. Each flow may be characterized by the following: a priority; a traffic class, such as CBR, rt-VBR, nrt-VBR, or UBR; and a corresponding set of traffic parameters specifying the rate at which cells should be transmitted and how much variation in the transmission rate is permissible. For the sake of simplicity, the following description assumes that the priority corresponds to the traffic class with CBR cells being given the highest priority and UBR cells being given the lowest priority. However, it should be understood that this convention need not be applied.

Referring now to FIG. 2, there is shown a schematic block diagram illustrating one embodiment of a traffic shaping system 200 configured in accordance with the present invention. This exemplary system depicts a basic arrangement of the traffic shaping system for one output port. The described system may similarly be applied to systems incorporating multiple output ports. In this exemplary traffic shaping embodiment, all ATM traffic passes through a shaping engine 202 running on the PP 106. Switched ATM traffic is sent via the NP 104. The NP 104 does not, in this example, handle fairness, prioritization or timing. Rather, cells received at the NP 104 from ports 206 are first passed to the shaping engine 202 on the PP 106. Once all ATM traffic has been shaped and scheduled, the PP 106 presents the NP 104 with a single ordered stream of cells 204 to send on each port 206. These cells are ready to send at the time in which they are inserted into the flow's buffer queue. With respect to transmission timing, the present application considers cells which have been placed on a buffer queue to have been sent. To put this another way, the PP/NP boundary is the effective transmission point for the shaping engine, since cells passed to the NP are considered to be transmitted. To enhance operation, the queue may be kept short to more effectively avoid jitter. All NP transmission is driven simply from the port hardware. Whenever an enabled transmission port has space available for another cell it asserts a hardware service request, which activates the appropriate device driver code in the NP.

Traffic shaping system 200 preferably includes two distinct interfaces between the PP 106 and the NP 104: a port transmission FIFO 208 and a port activation interface. In one configuration, the traffic shaping system 200 includes a Port Transmission FIFO 208 for each transmission port. In operation, the PP 106 inserts one entry into the FIFO for each cell to be transmitted, this entry containing the flow address for the cell. The entries are inserted in transmission order, and are similarly inserted at the time the PP 106 desires transmission.

In one embodiment of the present invention, transmission port activation may be a non-software (i.e., hardware) interface between the PP and NP. In this embodiment, the PP 106 causes the NP 104 to service a particular transmission port simply by enabling the port hardware. This is a very efficient mechanism because there is no need to send a software message between the two processors. The NP 104 responds to hardware service requests by outputting the cells corresponding to the entries in the Port Transmission FIFO 108. When there are no more cells to transmit on a particular port, the NP disables the port hardware again. Because both PP 106 and NP 104 can update the hardware register that enables and disable ports, one embodiment of the present system may further incorporate a hardware locking mechanism to avoid conflicts.

For locally originated ATM traffic, an ATM driver 214 on the PP 106 (and hence the shaping engine 202) receives locally originated traffic 216 as buffers corresponding to multiple transmitted cells (e.g., AAL5 packets). In one manner, the shaping engine 202 may focus on scheduling, while the NP 104 handles the segmentation into cells.

The interface between the NP 104 and the PP 106 is preferably comprised of an Activated Flow List (FIFO) 210 for enabling the NP 104 to pass switched ATM traffic to the PP 106 for shaping. For this switched ATM traffic (i.e., ATM cell traffic received at input ports 206), the NP 1 04 notifies the PP 106 of the receipt of a switched cell on a previously inactive flow via the Activated Flow List (FIFO) 210. The NP 104 adds flows to the List when they receive a switched cell (if they are not already active). The PP 106 reads from the Activated Flow List 610 each time it services the associated output port, and adds the relevant flows to the timing rings as described below.

The NP 104 performs most of the work of switching cells (such as buffering and rewriting the cell headers); one novel manner of doing this is discussed in detail below. The cells are then sent to their output ports via the shaping engine 202 on the PP 106. Note that switch buffers can still be owned (i.e., allocated and freed) entirely by NP even if the PP schedules them. Reshaping switched traffic via the PP increases the latency of switched traffic (but does not reduce the throughput).

In the present traffic shaping system 200, the NP 104 further handles multicast switching of ATM cells. Multicast switching is generally defined as the transmission of cells on multiple ports, by creating multiple copies of each cell (with appropriate headers) on the flow corresponding to each transmission branch. The branch flows are then passed individually to the PP to be treated as normal switched traffic. In this manner, the actual multicast operation is performed by the NP 104, with the resulting branched flows being passed from the PP for treatment as normal switched traffic.

In accordance with the present invention, traffic shaping may be implemented as a per-port attribute, and in one configuration will be enabled on one port only. That is, a device including several ports may be configured such that only a preset number of ports (i.e., one) are subject to traffic shaping. On ports with the traffic shaping attribute enabled, all traffic (both locally-originated and switched) is shaped. On other ports it may be desirable to transmit cells without using traffic shaping to avoid certain inefficiencies associated with shaping that may not be necessary for handling certain types of cell flows. There are several constraints: it is still desirable to preserve the priorities of the data streams, and it is still desirable to maintain some level of fairness between streams competing for transmission on the same port. This includes fairness between switched and locally originated traffic, and between traffic on different circuits.

For ports on which no traffic shaping is required, one embodiment for handling unshaped traffic may be to plug a null pacing handler into the described traffic shaping scheme. If a port is not shaped, cells take the current NP->PP->NP path, using the same fairness and priority queue, but the PP shaping engine 202 for an unshaped port does not include a timing ring as described in additional detail below. Instead, the timing ring has a latent queue for each priority level, with flows being removed from the front, passed to the NP 104, and put back on the tail of the queue.

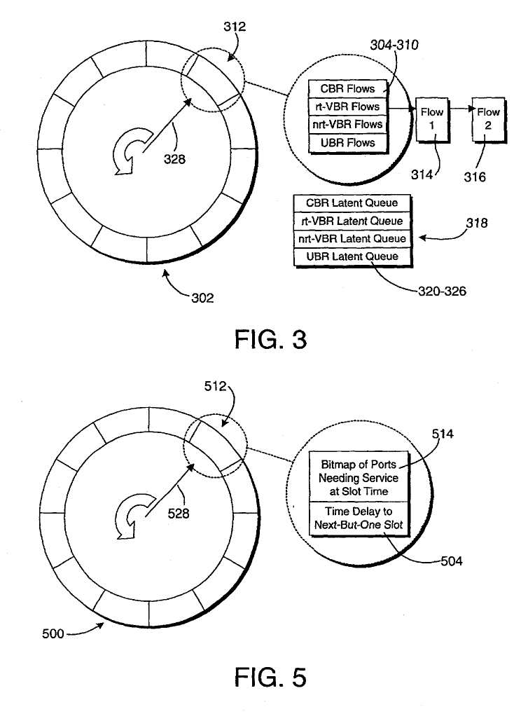

Referring now to FIG. 3, there is shown block diagram illustrating one embodiment of a timing structure for use in the traffic shaping engine 202 of the present invention. In this embodiment, the shaping engine 202 utilizes a timing ring 302 having four distinct priority levels 304, 306, 308 and 310 for each output port. In operation, each ring 302 rotates by one slot 312 at every transmission cell time on the associated port. Each ring slot 312 represents a transmission slot on the wire at a future time. Further, each slot 712 includes four fields corresponding to the four priority levels 304-310, and each field correspondingly points to a list of flows, e.g., 314 and 316, whose next cell should ideally be transmitted at that slot time. Each port also includes a latent queue 318 for each priority level, 320, 322, 324 and 326. These latent queues hold flows whose ideals next transmission time have already passed, and resolve contention for available transmission slots. Each ring 302 is preferably controlled by a handler routine in the PP 106 that is executed once for each cell time of the corresponding port.

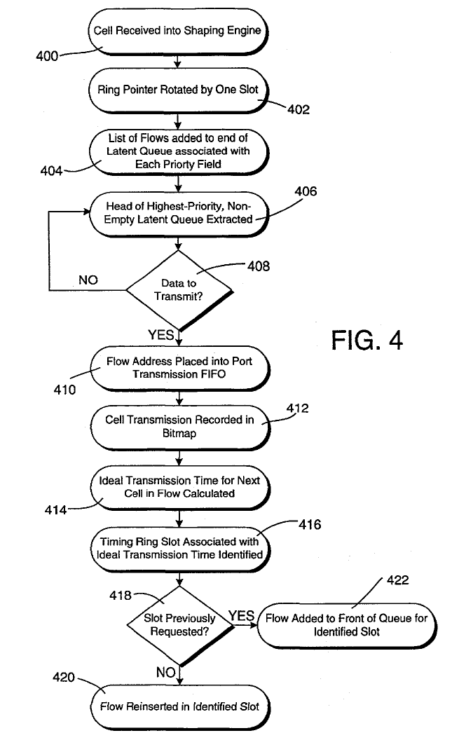

Referring now to FIG. 4, there is shown a flow diagram illustrating one embodiment of a method for shaping ATM traffic on an output port in accordance with the present invention. Initially, a cell is received into the shaping engine 202 in step 400. In step 402, a ring pointer 328 for timing ring 302 is rotated by one slot 312. Next, in step 404, for each priority field (304-310) within the slot, the list of flows associated therewith is removed and added to the end of the latent queue 318 for that priority. Next, in step 406, the head (i.e., next in line) flow from the highest-priority, non-empty latent queue, is extracted and, in step 408, it is determined whether it still has data to transmit.

If it is determined that the head flow has no data to transmit, the flow is forgotten and the process returns to step 406. If it is determined that the head flow includes data to transmit, the address for the associated flow is placed into the Port Transmission FIFO 208 in step 410, resulting in the transmission of the associated cell by the NP 104. In step 412, the fact that a cell has been transmitted on this port is recorded in a bitmap where the bit positions correspond to port numbers. In step 414, the ideal transmission time for the next cell from this flow is calculated by a scheduling handler routine belonging to the flow. In one embodiment, this calculating involves running the Generic Cell Rate (or leaky bucket) algorithm (GRCA) using the flow's traffic parameters and current state as input, and updating the current state.

Once the ideal transmission time for the next cell has been calculated, the corresponding slot 312 in timing ring 302 is identified in step 416. In step 418 it is determined whether another flow has already requested the identified slot. If not, the flow is reinserted in the identified slot in step 420. However, if the slot has been previously requested, the flow is add it to the front of the queue for the identified slot in step 422.

Returning now to FIG. 3, the timing ring 302 for each port rotates at a rate such that one slot 312 corresponds to a cell time on that port. Each port has a handler routine which may be called once per cell time on that port, either to rotate its timing ring one slot (shaped ports), or just to choose a cell based on priorities (unshaped ports). In accordance with the present invention unshaped ports may be serviced less often and their handlers may queue multiple cells for transmission in order to reduce overhead.

Referring now to FIG. 5, there is shown a block diagram of an master timing ring 500 which may be included to control when the handlers for the ports (both shaped and unshaped) are called. In this embodiment, the master ring 500 rotates at a variable speed, and each slot 512 holds a time delay field to support this timing. Further, each slot 512 contains a bitmap 514 showing which ports should be serviced at this particular slot time. The ring handler for each such port is then called individually. Preferably, the master ring 500 is constructed when the system starts up, and must be modified whenever a port speed changes. A timer interrupt is used to activate the master ring.

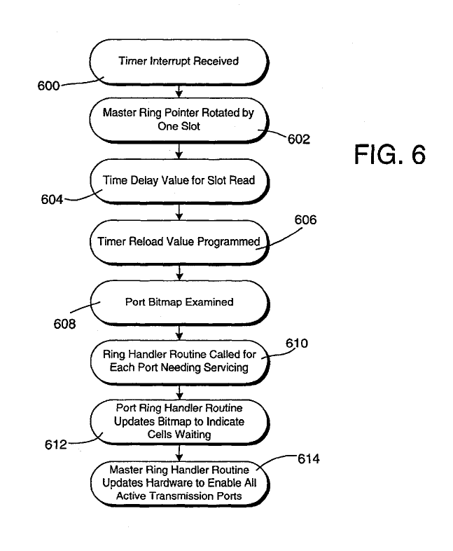

Referring now to FIG. 6, there is shown a flow diagram illustrating one embodiment of a method for scheduling port timing in accordance with the present invention. In step 600, a timer interrupt is received, thus activating the master ring 500. In response to the timer interrupt, the master ring pointer 528 is rotated by one slot 512 in step 602. In step 604, the time delay value 504 from that slot is read and, in step 606, the time delay value is used to program the reload value of the timer. In one embodiment, the timer has a current value and a reload value. The current value counts down at a fixed rate, and when it reaches zero the timer raises an interrupt and sets the current value from the reload value. This is why the stored value is the next-but-one delay—when the interrupt is serviced, the timer is already counting down the next delay.

Once the reload value is set, the port bitmap 514 is examined in step 608 and, in step 610, the ring handler routine is called for each port that needs servicing at this time. In step 612, each port ring handler routine updates the bitmap 514 to indicate whether or not it scheduled a cell for transmission, so the master ring handler builds up a complete map of which transmission ports have cells waiting. In step 614, the master ring handler routine updates the hardware to enable all the active transmission ports (and thus cause the NP to service them).

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

What is claimed is:

1. A system for scheduling transmission of asynchronous transfer mode cells, comprising:
a first processor connected to at least one port, wherein the first processor performs port management functions, low level cell handling and cell switching; and
a second processor operatively connected to the first processor through a shared memory, the second processor performing cell traffic shaping and scheduling operations,
wherein ATM cells are passed between the second processor and the first processor in an ordered, timed cell stream for transmission on the at least one port.

2. The system of claim 1, wherein the second processor further comprises:
a shaping engine for receiving locally originated ATM cell traffic and switched ATM cell traffic received at a port,
wherein the shaping engine operates to schedule the delivery of the locally originated and switched ATM cell traffic to the first processor in an ordered, timed cell stream for transmission on the at least one port.

3. The system of claim 2, wherein the second processor further comprises an ATM driver for receiving the locally originated ATM cell traffic and passing it to the shaping engine for scheduling.

4. The system of claim 2, wherein locally originated ATM cell traffic includes ATM cells generated by the second processor and data packets bridged or routed from other network interfaces.

5. The system of claim 2, further comprising:
a first interface between the first processor and the second processor across which switched ATM cell traffic received at the at least one port is transmitted to the shaping engine for scheduling; and
a second interface between the second processor and the first processor across which the ordered, timed cell stream is transmitted from the shaping engine to the first processor for transmission on the at least one port.

6. The system of claim 5, wherein the first interface comprises a memory structure stored on the shared memory for storing the switched ATM cell traffic received at the at least one port.

7. The system of claim 6, wherein the memory structure is a first-in-first-out memory structure.

8. The system of claim 8, wherein the second interface comprises a memory structure stored on the shared memory for storing the ordered, timed cell stream.

9. The system of claim 8, wherein the memory structure is a first-in-first-out memory structure, wherein ATM cell traffic is added to the a first-in-first-out memory structure upon receipt of a cell at a previously inactive port.

10. The system of claim 5, wherein the first processor outputs multicast cell traffic to the shaping engine across the first interface.

11. The system of claim 2, further comprising a port activation interface between the second processor and the first processor across which port activation requests are transmitted which result in the transmission of ATM cells from the at least one port.

12. The system of claim 2, wherein the shaping engine further comprises:
means for utilizing a timing ring stored in the shared memory, wherein

13. A method for scheduling transmission of asynchronous transfer mode cells, comprising the steps of:
maintaining a timing ring in a memory structure operatively connected to a traffic shaping engine and an output port,
wherein the timing ring is a circular collection of time slots relating to cell transmission at the output port, each time slot having a list of flow structures and a list of latent queues corresponding to supported traffic priorities;
receiving an ATM cell into the traffic shaping engine;
rotating a ring pointer for the timing ring by one slot to a current time slot;
removing the list of flows associated within the current time slot for each supported priority and adding the list of flows to the end of the time slot's latent queue, respectively;
extracting a flow from the latent queue corresponding to the next-in-line, non-empty flow having the highest-priority;
determining whether the identified flow still has data to transmit;
forgetting the identified flow if it is determined that the identified flow has no data to transmit; and
placing an address associated with the identified flow into a first-in-first-out memory structure operatively connected to the output port, resulting in transmission of the ATM cell from the output port.

14. The method of claim 13, wherein the supported traffic priorities include at least CBR, rt-VBR, nrt-VBR, and UBR.

15. The method of claim 13, further comprising the steps of:
recording the transmission of the ATM cell in a bitmap memory structure, wherein bit positions in the bitmap memory structure correspond to port numbers;
calculating an ideal transmission time for the next cell from the flow;
identifying the time slot in the timing ring corresponding to the calculated ideal transmission time;
determining whether another flow has already requested the identified time slot;
reinserting the flow in the identified slot if it is determined that another flow has not already requested the identified time slot; and
adding the flow to the front of the latent queue for the identified slot if it is determined that another flow has already requested the identified time slot.

16. The method of claim 15, wherein the step of calculating an ideal transmission time for the next cell from the flow is performed by a scheduling handler routine belonging to the flow.

17. A computer readable medium incorporating instructions for scheduling transmission of asynchronous transfer mode cells, the instructions comprising:
one or more instructions for maintaining a timing ring in a memory structure operatively connected to a traffic shaping engine and an output port,
wherein the timing ring is a circular collection of time slots relating to cell transmission at the output port, each time slot having a list of flow structures and a list of latent queues corresponding to supported traffic priorities;
one or more instructions for receiving an ATM cell into the traffic shaping engine;
one or more instructions for rotating a ring pointer for the timing ring by one slot to a current time slot;
one or more instructions for removing the list of flows associated within the current time slot for each supported priority and adding the list of flows to the end of the time slot's latent queue, respectively;
one or more instructions for extracting a flow from the latent queue corresponding to the next-in-line, non-empty flow having the highest-priority;
one or more instructions for determining whether the identified flow still has data to transmit;
one or more instructions for forgetting the identified flow if it is determined that the identified flow has no data to transmit; and
one or more instructions for placing an address associated with the identified flow into a first-in-first-out memory structure operatively connected to the output port, resulting in transmission of the ATM cell from the output port.

18. The computer readable medium of claim 17, wherein the supported traffic priorities include at least CBR, rt-VBR, nrt-VBR, and UBR.

19. The computer readable medium of claim 17, the instructions further comprising:
one or more instructions for recording the transmission of the ATM cell in a bitmap memory structure, wherein bit positions in the bitmap memory structure correspond to port numbers;
one or more instructions for calculating an ideal transmission time for the next cell from the flow;
one or more instructions for identifying the time slot in the timing ring corresponding to the calculated ideal transmission time;
one or more instructions for determining whether another flow has already requested the identified time slot;
one or more instructions for reinserting the flow in the identified slot if it is determined that another flow has not already requested the identified time slot; and
one or more instructions for adding the flow to the front of the latent queue for the identified slot if it is determined that another flow has already requested the identified time slot.

20. The computer readable medium of claim 19, wherein the one or more instructions for calculating an ideal transmission time for the next cell from the flow are performed by a scheduling handler routine belonging to the flow.
